(19) United States
(12) Patent Application Publication
(10) Pub. No.: US 2015/0168981 A1
(43) Pub. Date: Jun. 18, 2015

(54) HYBRID HIGH-INERTIA SYNCHRONOUS CONDENSER FACILITY

(71) Applicant: General Electric Company, Schenectady, NY (US)

(72) Inventors: John Paul SKLIUTAS, Clifton Park, NY (US); Chris Owen SCHARTNER, Peterborough (CA); Miaolei SHAO, Altamont, NY (US)

(73) Assignee: General Electric Company, Schenectady, NY (US)

(21) Appl. No.: 14/105,546

(22) Filed: Dec. 13, 2013

(51) Int. Cl. G05F 1/70

(52) U.S. Cl. CPC G05F 1/70

(57) ABSTRACT

A hybrid high inertia synchronous condenser facility for delivering reactive power to an electrical grid comprises at least one synchronous condenser, a voltage transformer connecting the at least one synchronous condenser to an electrical grid, at least one bank of capacitors switchably connected to the electrical grid, at least one bank of reactors switchably connected to the electrical grid, and a controller for controlling connection of the voltage transformer, the at least one bank of shunt capacitors, and the at least one bank of shunt reactors to the electrical grid. The synchronous condenser is equipped with a flywheel.

### FIELD OF THE INVENTION

The present invention generally relates to synchronous condenser, and more specifically to high-inertia synchronous condenser.

### BACKGROUND OF THE INVENTION

The frequency response of power systems is decreasing due to the displacement of conventional power plants with alternate power sources such as wind plants (without inertia option) and solar plants. In addition, motor loads are increasingly connected to variable speed drives that de-couple the machine from the grid.

As conventional power plants are replaced by alternative power sources, such as wind plants and solar plants, and as more and more synchronous and induction motors are connected to the grid via motor drives, the inertia associated with these conventional power plants and motors are also removed from the electric power grid. The inertia is an energy stored as rotating energy in machines on a system. One way to restore the inertia to the grid is through use of synchronous condensers. Directly connected synchronous machines and induction motors contribute to inertia.

Synchronous condenser is a device commonly used to adjust conditions on the electric power transmission grid. Synchronous condensers have many characteristics which can benefit the power grid including: the ability to generate or absorb reactive power to adjust the grid's voltage, provide short circuit current, have reactive power overload capability, have excellent fault ride-through capability, as well as provide inertia to the power grid. Synchronous condenser has an inertia constant (H), and depending on the machine design, H varies from approximately 0.75 to 2.5 for horizontal shaft machines. This value compares to approximately 4 to 8 for power plants which obtain additional inertia from the turbine.

Normally, the synchronous condenser has an inertia constant H in the order of approximately 2. When a large amount of inertia is desired for a grid, multiple synchronous condensers are used or larger condensers are used, and this increases the cost for adding the inertia to the power grid.

Therefore, it is to an alternative system that provides inertia at a lower cost that the present invention is primarily directed.

### SUMMARY OF THE EMBODIMENTS

Embodiments of the present invention overcome the aforementioned deficiencies noted in the conventional modeling methods.

In one embodiment, a hybrid high-inertia synchronous condenser facility is provided. The hybrid high-inertia synchronous condenser facility comprises at least one synchronous condenser, a voltage transformer connecting the at least one synchronous condenser to an electrical grid, at least one bank of capacitors switchably connected to the electrical grid, at least one bank of reactors switchably connected to the electrical grid, and a controller for controlling connection of the voltage transformer, the at least one bank of shunt capacitors, and the at least one bank of shunt reactors to the electrical grid.

In another embodiment, a method for delivering reactive power from a hybrid high inertia synchronous condenser facility to an electrical grid is provided. The method comprises monitoring the electrical grid, monitoring the hybrid high inertia synchronous condenser facility, computing an amount of reactive power to be delivered by the hybrid high inertia synchronous condenser facility, controlling operations of the hybrid high inertia synchronous condenser facility according to a computation result.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 is a graphic that shows effects of a disturbance on a power grid;

FIG. 2 is a diagram of an apparatus for introducing inertia and reactive power into a power grid;

FIG. 3 is a diagram of an alternative system for providing the same inertia as the apparatus in FIG. 2;

FIG. 4 is a diagram of a hybrid high-inertia synchronous condenser facility according to the present invention;

FIG. 5 is a chart illustrating comparison of results from different approaches for increasing inertia to a power grid; and

FIG. 6 is a flowchart for operation of a controller.

### DETAILED DESCRIPTION OF THE PREFERRED EMBODIMENTS

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The hybrid high-inertia synchronous condenser facility of the present invention provides a high inertia constant that reduces the number of conventional condensers or the total installed condenser MVAr nameplate capacity to achieve the desired amount of inertia. The synchronous condenser facility of the present invention uses a fly wheel to increase the inertia constant H and also uses banks of shunt capacitors and/or shunt reactors together with the reactive power rating of the condenser to provide the required level of leading and lagging MVArs to the grid.

The synchronous condenser facility of the present invention can deliver the inertial effect of a large synchronous condenser through a small synchronous condenser with a fly wheel while shunt capacitors and/or shunt reactors compliment the condenser reactive rating such that the desired level of compensation is provided to the grid.

The main technical advantage of the hybrid high-inertia synchronous condenser facility of the present invention is that a single machine can appear to the power grid as multiple machines (from an inertia perspective) and enables the option to reduce the total machine MVAr rating to reduce cost and make up the reduction in condenser nameplate MVArs with low cost shunt capacitors, shunt reactors, and a controller.

The inertia constant H is calculated according to the equation below:

$$H = \frac{Kinetic energy at rated speed}{VAbase} = \frac{1}{2} \frac{J {ω}^{2}}{VAbase}$$

H=Inertia constant in MWs/MVA.
J=Moment of Inertia in kg m².
ω=nominal speed of rotation in radians/s.
VAbase=MVA rating of machine

In a power generation facility, under steady state, mechanical energy (M) and electrical energy (E) are balanced. When a power plant is lost or trips, electrical energy (load) is greater than mechanical energy, and system frequency drops. The rate of frequency drop (df/dt) is a function of initial power mismatch and the inertia constant H of the system. The machine speed in the power generation facilities decline until the mechanical power increases to match the electrical load when a new steady state is reached.

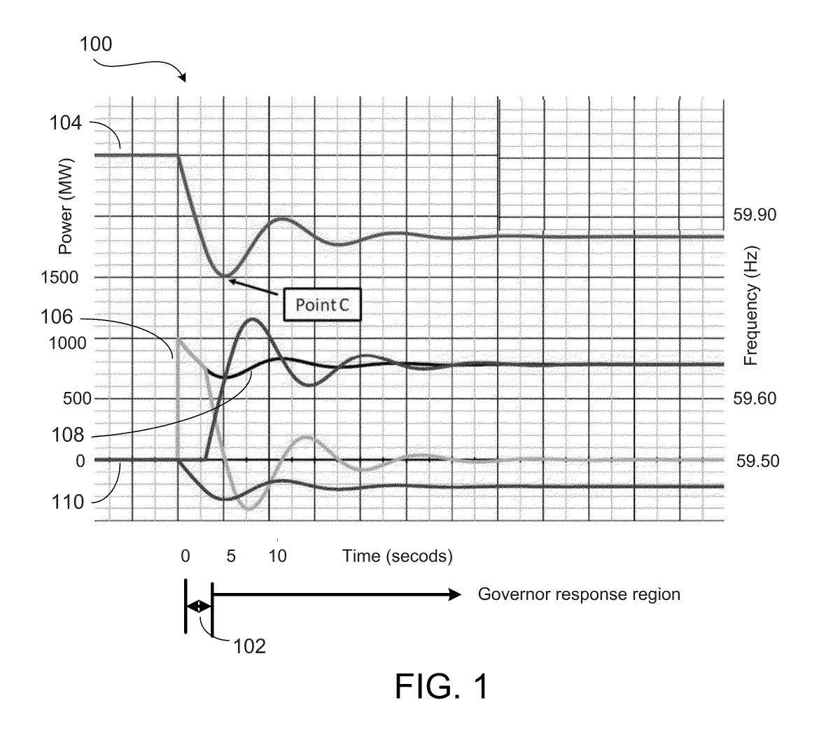

FIG. 1 is a graphic 100 taken from Frequency Response Initiative Report prepared by North American Electric Reliability Corporation (NERC) and shows effects of a disturbance on a power grid, e.g., when a power plant is lost. When the disturbance occurs, e.g., a certain power plant is removed, balancing inertia (line 106) is extracted from the energy stored in spinning rotors until the governor response (line 110) kicks in with a delay and the governor response denotes the end of the inertia response region 102. The power deficit (line 108) oscillates and then stabilizes at a certain value. In the example of FIG. 1, the power deficit stabilizes at approximately 800 Mega Watts (MW). The frequency response (line 104) initially drops and oscillates to stabilize. The inertia affects the duration of the inertia response region 102. High inertia decreases the slope of df/dt and can reduce the lowest dip in frequency, point C.

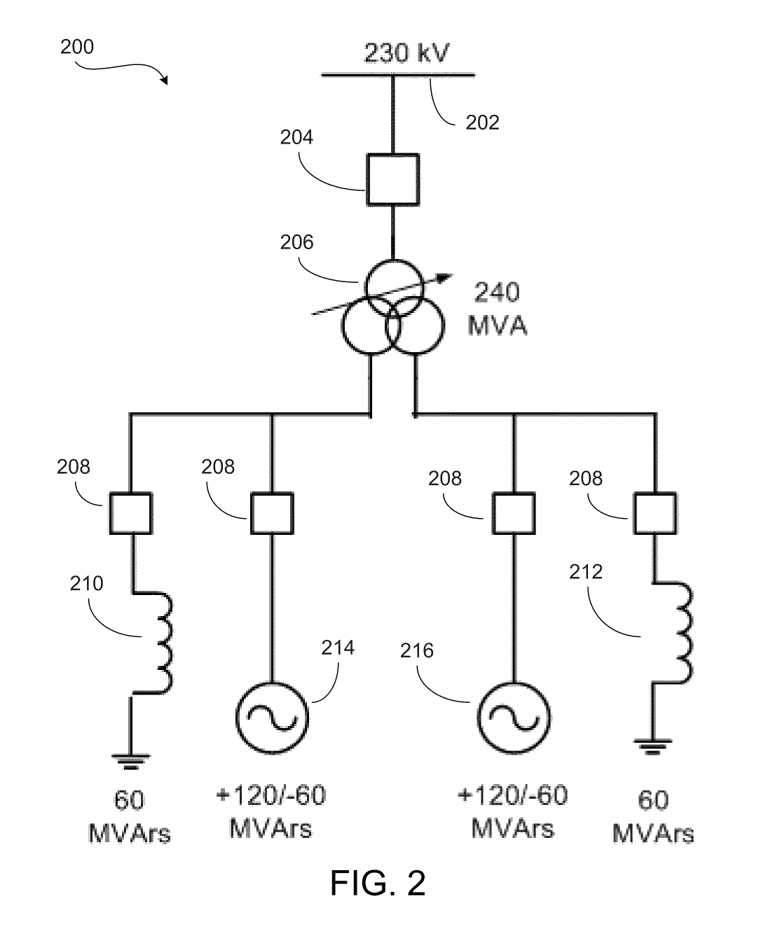

FIG. 2 is a diagram of an apparatus 200 for introducing inertia into a power grid 202. The apparatus 200 introduces inertia and reactive power into a power grid with two machines, each rated +120/−60 MVArs. The apparatus 200 is connected to the grid at bus (or node 202) through a switch (circuit breaker) 204. The apparatus 200 has two shunt reactive components (shunt reactors) 210, 212, and two machine components (synchronous condenser) 214, 216. Each synchronous condenser 214, 216 have conventional inertia constants, i.e. approximately 2.

Each shunt reactive component and machine component is connected through a switch 208. Each reactive component 210 can absorb 60 mega volt-ampere reactive (MVAr) of reactive power and each machine can supply 120 MVArs or absorb 60 MVArs (+120 MVArs means 120 MVArs from the apparatus 200 to the grid 202 and −60 MVArs means 60 MVArs from the grid 202 to the apparatus 200, ignoring reactive losses in the transformer). The output from the components passes through a transformer 206 for adjusting the voltage of the output from the components to the voltage of the grid 202. The output from the transformer 206 is 240 MVA minus the reactive loss in the transformer. The transformer 206 may be equipped with a tap changer (not shown). The apparatus 200 provides an inertia rated as 2*120H or 480 MWs if H=2.

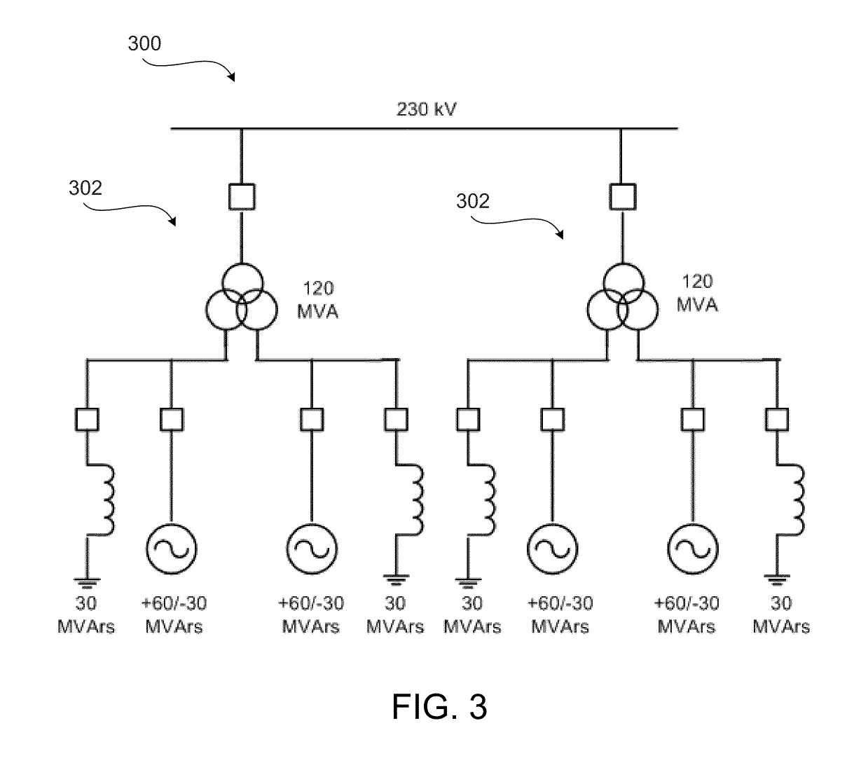

The same inertia from the apparatus 200 can be provided through a different configuration shown in FIG. 3. The apparatus in FIG. 3 provides the same inertia and reactive power into a power grid with four smaller machines, each rated +60/−30 MVArs, provided the H constant of the machines in FIG. 2 and FIG. 3 are the same. Instead of using a larger synchronous condenser, as shown in FIG. 2, smaller capacity components can be used. The configuration 300 shows two apparatus 302 used, each apparatus 302 uses components of half capacity compared with the components of FIG. 2. Each apparatus 302 comprises of two shunt reactive components and two machine components. Each shunt reactive component can absorb 30 Mega volt-ampere reactive (MVAr) of reactive power and each machine component can supply 60 MVArs. The two shunt reactive components and two machine components are connected to a transformer as the apparatus in FIG. 2 and these transformers are in turn connected to the grid through a circuit breaker. The total inertia can be delivered by the two apparatus 302 in FIG. 3 is the sum of the inertia delivered by each apparatus 302. The sum of the inertia delivered by two apparatus 302 is 2*60*2*2 or 480 MWs if H=2.

The configuration of FIG. 3 may be easier to obtain and to use than the configuration of FIG. 2 because a higher number of machines can offer flexibility relative to machine maintenance and/or outages since the loss of one machine removes 25% of the facility capacity compared 50% when a total of two machines is considered per FIG. 2.

For some conditions, the components with higher capacity may not be available or may not be suitable in stations with limited available space.

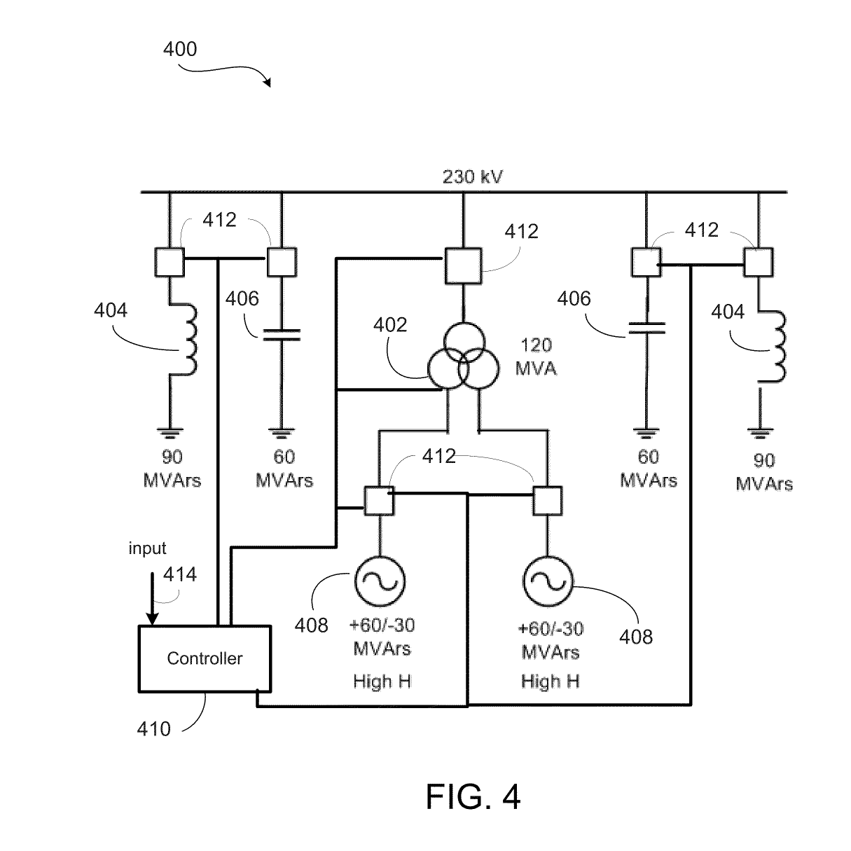

There is yet another way to deliver inertia and MVArs to the grid as the configurations denoted in FIG. 2 and FIG. 3 is shown in FIG. 4, which is easy to implement and low cost. FIG. 4 depicts a diagram of a hybrid high-inertia synchronous condenser facility 400 according to the present invention. The synchronous condenser facility 400 is a hybrid high-inertia facility because it delivers inertia through a combination of two machine component 408, two shunt reactors 404, and two shunt capacitors 406. Each machine component 408 is a high inertia H synchronous condenser with a flywheel attached. Each machine component 408 is capable of providing as much inertia as the synchronous condensers in FIG. 2 by adding the flywheel. The two high inertia synchronous condensers 408 are connected to the grid through a transformer 402.

By adding a flywheel to the synchronous condenser, the H of the synchronous condenser with an H of nominal value of 2 can be increased to 3 or more including 6 to 8 and beyond if required and the design made feasible. The addition of a flywheel to the synchronous condenser can reduce the required amount of machine capacity for a given application while the overload capacity of the machine plus shunt capacitors and/or shunt reactors, which are all controlled by a controller, can operate satisfactory and have the necessary MVArs for quasi and steady state voltage regulation and can replace an all-machine installation at a lower cost, smaller footprint, and lower operating losses while providing the same or more inertia to the system compared to the all-machine option.

The two high inertia synchronous condensers 408 provide a total of 2*60*4=480 MVAs for H=4 and the missing MVAr capacity of the facility 400 is provided by banks of shunt reactors 404 and shunt capacitors 406. Each bank of shunt reactors provides −90 MVArs and each bank of shunt capacitors provides 60 MVArs. So the total capacity of the facility 400 is +240/−240 MVArs (ignoring MVArs losses in the transformer). This hybrid facility 400 has banks of shunt reactors, banks of shunt capacitors, and multiple high-inertia synchronous condensers 408.

The operation of the synchronous condenser facility 400 is controlled by a controller 410. The controller 410 determines when shunt elements (banks of capacitors and/or banks of shunt reactors) are connected to the grid and how much MVArs are provided or absorbed by the synchronous condenser with fly wheel (by adjusting a field current for each condenser).

The controller 410 controls all the circuit breakers 412 and also the synchronous condenser 408, the tap changer in the transformer 402 (if provided), and banks of shunt reactors 404 and shunt capacitors 406. The controller 410 may be a computing device with a non-transitory storage unit (memory) and a set of instructions inside the storage unit. The controller 410 is programmed by a user and executes the programmed instructions to control delivery of dynamic reactive power by the facility 400. The controller 410 monitors the power grid and the operation of different components of the hybrid high-inertia synchronous condenser facility 400 through information received through the input 414. The amount of reactive power absorbed or delivered to the grid (bus) is controlled by the controller 410 according to the instructions and the information received.

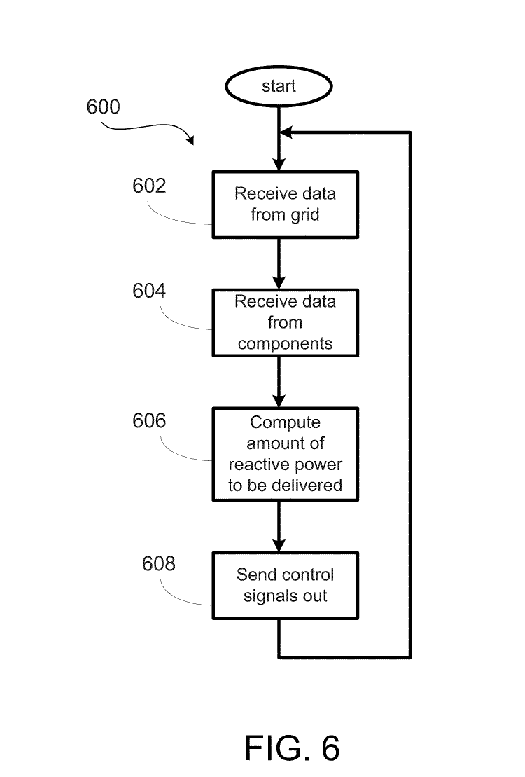

FIG. 6 is a flowchart 600 for the operations of the controller 410. The controller receives data about the grid from the input 414, step 602, and also receives data about components in the synchronous condenser facility 400, step 604. The controller 410 calculates the amount of reactive power needed for the system to stay in balance, step 606, and sends control signals to control the circuit breakers and also other components in the synchronous condenser facility 400, step 608. The controller 410 monitors the system and the facility continuously.

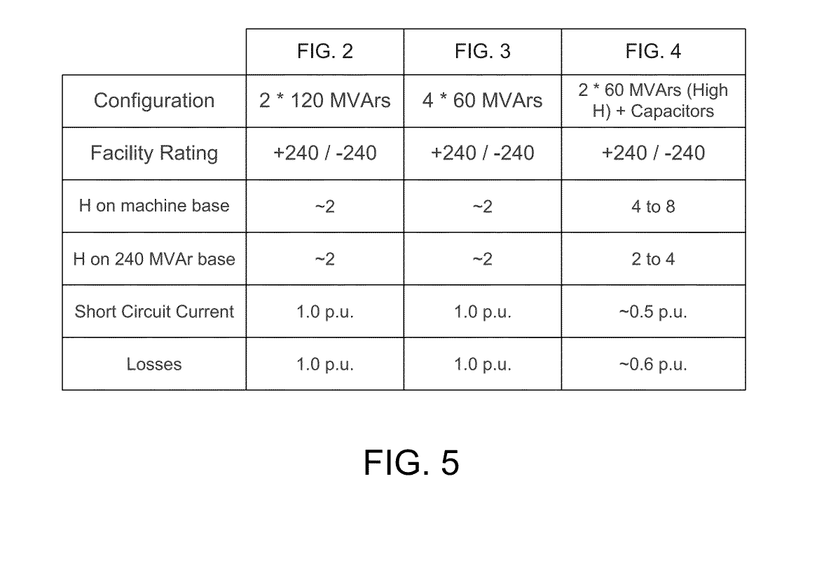

FIG. 5 is a chart illustrating comparison of results from different approaches, illustrated by FIGS. 2, 3, and 4, for increasing inertia to a power grid. All three configurations have an identical rating of +240/−240 MVArs (ignoring MVAr losses in the transformer), but the inertia constant H for the machine base is higher for the configuration 400.

The hybrid high-H synchronous condenser facility of the present application takes advantage of (1) the flywheel that can make a single condenser act on the grid, from an inertia perspective, as multiple condensers and (2) the low-cost shunt capacitors and reactors, which are up to an order of magnitude less cost per MVAr compared to traditional condenser MVArs, for reducing the nameplate of the condenser and lowering the cost of the overall installation compared to an all-machine installation.

The operation of the synchronous condenser and the switched shunt capacitors and/or reactors are all controlled by a controller that can be programmed or structured to operate according to an objective function that varies from installation to installation depending on the customer's requirements. For example, the objective function can include, but not be limited to: regulating a bus (or the machine terminals) to a voltage setpoint, regulating to a MVAr setpoint, i.e. providing a constant level of MVArs to the grid, operating the condenser facility at or near 0 MVArs (floating) to minimize losses, regulating a voltage at the bus only after leaving a deadband, and other control objectives as required by the customer.

The deadband is one of the control modes defined by the user. An example of the deadband is to provide no MVArs when the voltage is within a range and then operate, i.e. provide or absorb MVArs, when voltage is outside the range, e.g. do not provide or absorb MVArs when the voltage is between 95% and 105% but provide MVArs when voltage drops below 95% and absorb MVArs when voltage exceeds 105%.

The hybrid high-H synchronous condenser facility of the present application provides dynamic reactive power via operation of the automatic voltage regulator (AVR) during a fault and clear scenario, regulates the quasi and steady state voltage, provides inertia to the electrical grid system, and provides local short circuit current. The most common applications for synchronous condensers are near high-voltage direct current (HVDC) terminals and remote wind plants that use the condenser to provide short circuit current. AVR is an excitation system controlling the field current in the condenser via field voltage to maintain a voltage or MVAr setpoint.

Because a high inertia constant H can be achieved with addition of a relatively inexpensive fly wheel (compared to additional condenser(s)) and banks of shunt capacitors and shunt reactors are also utilized, the delivery of desired reactive power together and the desired level of inertia to the grid can be provided at a lower cost.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims. It is understood that features shown in different figures can be easily combined within the scope of the invention.

What is claimed is:

1. A hybrid high-inertia synchronous condenser facility comprising:
at least one synchronous condenser;
a voltage transformer connecting the at least one synchronous condenser to an electrical grid;
at least one bank of capacitors switchably connected to the electrical grid;
at least one bank of reactors switchably connected to the electrical grid; and
a controller for controlling connection of the voltage transformer, the at least one bank of shunt capacitors, and the at least one bank of shunt reactors to the electrical grid.

2. The hybrid high-inertia synchronous condenser facility of claim 1, wherein the at least one synchronous condenser further comprises a flywheel.

3. The hybrid high-inertia synchronous condenser facility of claim 2, wherein the at least one synchronous condenser having an inertia constant is above value of 2.

4. The hybrid high-inertia synchronous condenser facility of claim 2, wherein the at least one synchronous condenser having an inertia constant is above 8.

5. The hybrid high-inertia synchronous condenser facility of claim 1, wherein the voltage transformer further comprises a tap changer.

6. The hybrid high-inertia synchronous condenser facility of claim 1, wherein there are two synchronous condensers.

7. The hybrid high-inertia synchronous condenser facility of claim 1, wherein the controller further comprises a computing device and a non-transitory storage unit for storing computer instructions, when the computer instructions are executed by the computing device, the controller monitors operations of the voltage transformer, the at least one bank of shunt capacitors, and the at least one bank of shunt reactors.

8. The hybrid high-inertia synchronous condenser facility of claim 7, wherein the controller performs operations of:
receiving data about the electrical grid;
receiving data about the voltage transformer, the at least one bank of shunt capacitors, and the at least one bank of shunt reactors;
computing amount of reactive power to be delivered to the electrical grid; and
controlling the voltage transformer, the at least one bank of shunt capacitors, and the at least one bank of shunt reactors according to the computed amount.

9. A method for delivering reactive power from a hybrid high inertia synchronous condenser facility to an electrical grid, comprising the steps of:
monitoring, by a controller, the electrical grid;
monitoring, by the controller, the hybrid high inertia synchronous condenser facility;
computing, by the controller, an amount of reactive power to be delivered by the hybrid high inertia synchronous condenser facility;
controlling, by the controller, operations of the hybrid high inertia synchronous condenser facility according to a computation result.

10. The method of claim 9, wherein the step of monitoring the electrical grid further comprises receiving, by the controller, data about the electrical grid.

11. The method of claim 9, wherein the step of monitoring the hybrid high inertia synchronous condenser facility further comprises receiving, by the controller, data about the hybrid high inertia synchronous condenser facility.

12. The method of claim 9, wherein the hybrid high inertia synchronous condenser facility further comprising at least one synchronous condenser, a voltage transformer connecting the at least one synchronous condenser to an electrical grid, at least one bank of capacitors switchably connected to the electrical grid, at least one bank of reactors switchably connected to the electrical grid and a controller.
